(19) United States
(12) Patent Application Publication
(10) Pub. No.: US 2014/0251099 A1
(43) Pub. Date: Sep. 11, 2014

(54) SCISSOR APPARATUS AND RELATED METHODS

(71) Applicant: Quirky, Inc., New York, NY (US)

(72) Inventors: Sonia COVARRUBIAS-GARCIA, San Pedro, CA (US); Faris ELMASU, Brooklyn, NY (US); Kate Sarah VALLON, Suffern, NY (US); Nicholas OXLEY, New York, NY (US)

(21) Appl. No.: 14/197,868

(22) Filed: Mar. 5, 2014

Related U.S. Application Data
(60) Provisional application No. 61/774,250, filed on Mar. 7, 2013.

(51) Int. Cl. B26B 13/12

(52) U.S. Cl. CPC B26B 13/12
USPC 83/13; 30/155

(57) ABSTRACT

An exemplary aspect comprises a scissors apparatus comprising: (a) a first member comprising a first handle component and a first blade component; and (b) a second member comprising a second handle component and a second blade component; said second member connected to said first member and pivotally movable with respect to said first member between a fully closed position and a fully open position, and said second handle component configured to enclose a sharpened portion of said first blade component when said first and second members are in said fully open position. An exemplary method aspect comprises operating any of the apparatus aspects and embodiments as scissors; opening said apparatus so that said first and second members are in said fully open position; and operating said apparatus as a single-blade cutting device.

### CROSS-REFERENCE TO RELATED APPLICATIONS

This application claims priority under 35 U.S.C. 119(e) to U.S. Provisional Patent Application No. 61/774,250, filed Mar. 7, 2013, entitled “Scissor Apparatus and Related Methods.” The entire contents of the above-referenced application are incorporated herein by reference.

### INTRODUCTION

An exemplary apparatus embodiment comprises a pair of scissors which protects one of the blades (for example, when using the other blade when scoring).

In an embodiment, the top handle conceals, or at least partially encloses, one of the blades, creating a comfortable handle when using scissors to score or even for curling ribbon, making these tasks easy and safe.

Exemplary dimensions: 215 mm L×94 mm W×12 mm D. Exemplary materials: plastic handles, with TPE (thermoplastic elastomer) co-molded touch points.

For everyday use, an exemplary embodiment resembles a normal pair of scissors, with an ergonomic handle. However, a groove in the handle conceals one of the scissor blades when the scissors are fully opened.

An exemplary aspect comprises a scissors apparatus comprising: (a) a first member comprising a first handle component and a first blade component; and (b) a second member comprising a second handle component and a second blade component; said second member connected to said first member and pivotally movable with respect to said first member between a fully closed position and a fully open position, and said second handle component configured to enclose a sharpened portion of said first blade component when said first and second members are in said fully open position.

In various exemplary embodiments: (1) said second handle component is configured to enclose said sharpened portion of said first blade component via a groove in said second handle component; (2) said second handle component uses a friction component in order to keep said sharpened portion of said first blade component secure within said second handle component when said first and second members are in said fully open position; (3) said friction component uses TPE contact with said first blade component; and (4) said second handle component uses a tab in order to keep said sharpened portion of first blade component secure within said second handle component when said first and second members are in said fully open position.

An exemplary method aspect comprises operating any of the apparatus aspects and embodiments as scissors; opening said apparatus so that said first and second members are in said fully open position; and operating said apparatus as a single-blade cutting device.

Further aspects, details, and embodiments will be apparent from the drawings and the description below.

### BRIEF DESCRIPTION OF THE DRAWINGS

FIG. 1 depicts an embodiment in a closed configuration (110) and a fully open configuration (120).

FIG. 2 depicts exemplary usage of an embodiment as traditional scissors or shears.

FIG. 3 depicts a user opening the scissors fully, so as to conceal one blade within the opposing handle.

FIG. 4 depicts exemplary usage of an embodiment as “box cutter” to slice tape on a cardboard box.

FIG. 5 depicts exemplary usage of an embodiment for curling ribbons.

FIG. 6 is a line drawing of an exemplary embodiment, showing a groove 610 in a handle, configured to receive an opposing blade.

FIGS. 7-9 provide additional views of a handle comprising groove 610.

FIGS. 10-11 are line drawings of an exemplary embodiment.

FIG. 12 is a line drawing showing certain internal components of an exemplary embodiment.

FIG. 13 is another view depicting a groove 610 in a handle of an embodiment.

### DETAILED DESCRIPTION OF CERTAIN EXEMPLARY EMBODIMENTS

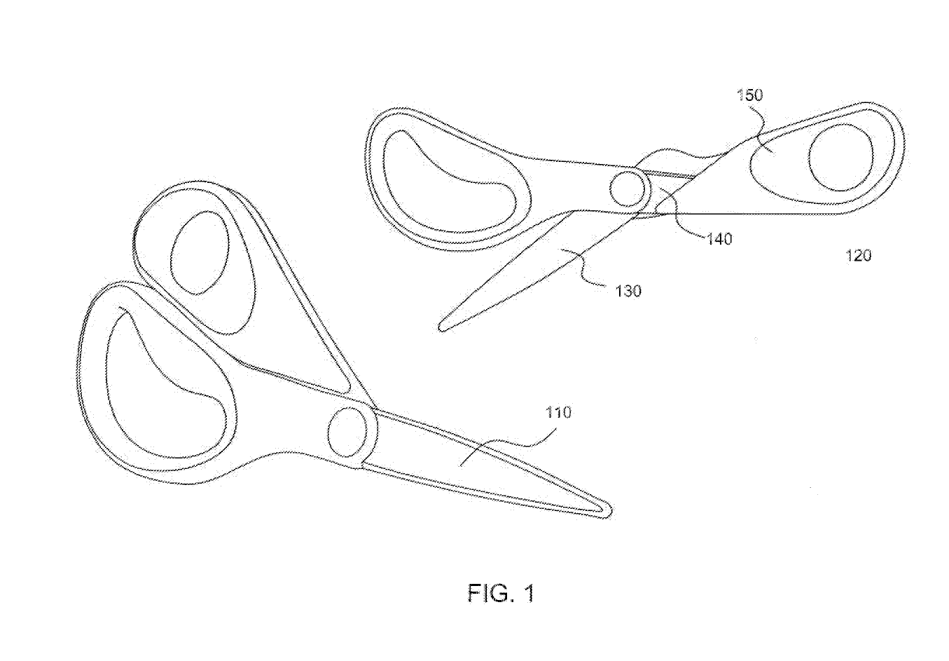

An exemplary embodiment is depicted in FIG. 1, wherein an embodiment is depicted in a closed configuration (110) and a fully open configuration (120). In the fully open configuration, a first blade 130 is exposed for usage in tasks such as opening boxes, scoring paper, or curling ribbons, while a second blade 140 is concealed within a groove in handle 150. The depicted embodiment comprises two cooperating members that are interconnected so as to be pivotally movable, with respect to each other and about a connection point, between open position 120 and closed position 110.

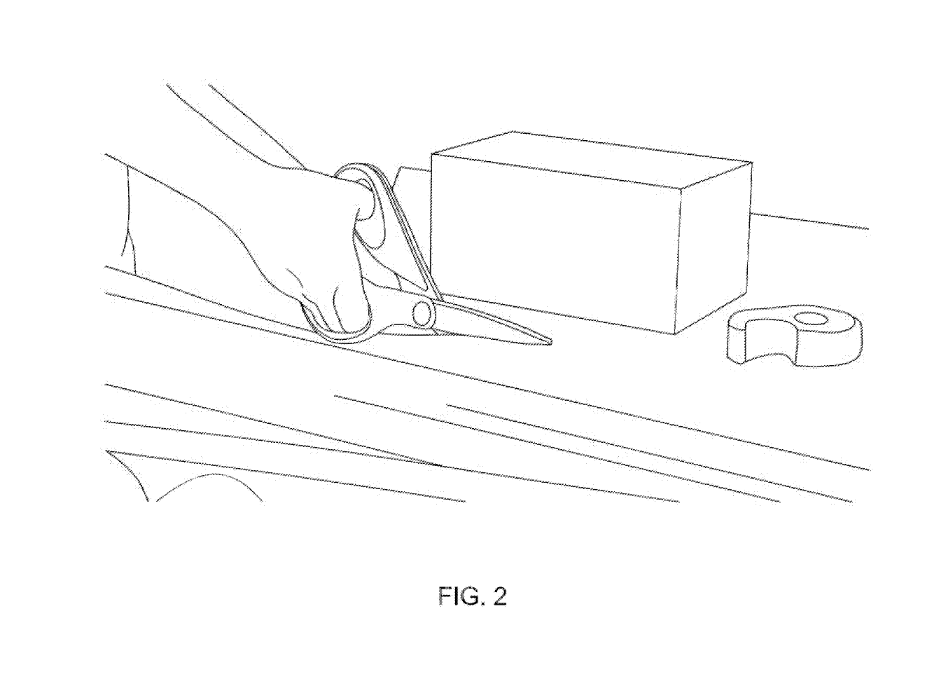

FIG. 2 depicts exemplary usage of an embodiment as traditional scissors or shears.

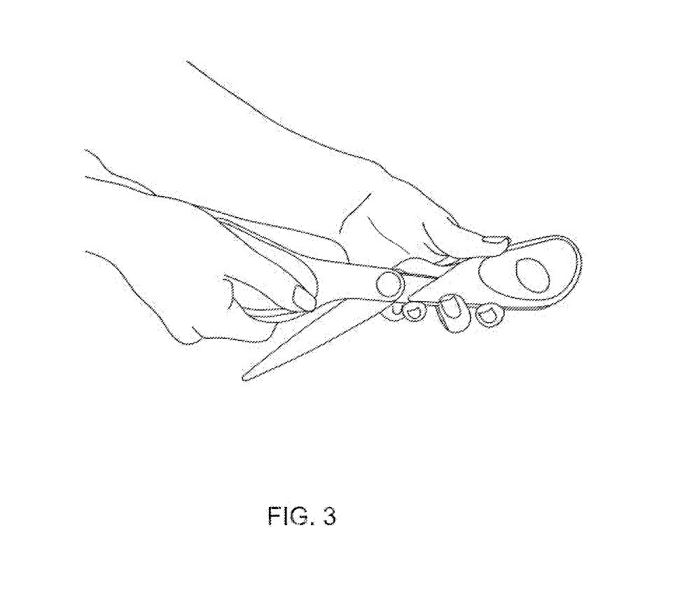

FIG. 3 depicts a user opening the scissors fully, so as to conceal one blade within the opposing handle.

In an exemplary embodiment, a friction feature (e.g., TPE contact with the metal blade) may be used in order to keep the blade secure within the handle. In other embodiments, other means for securing the blade (e.g., a tab) may be used.

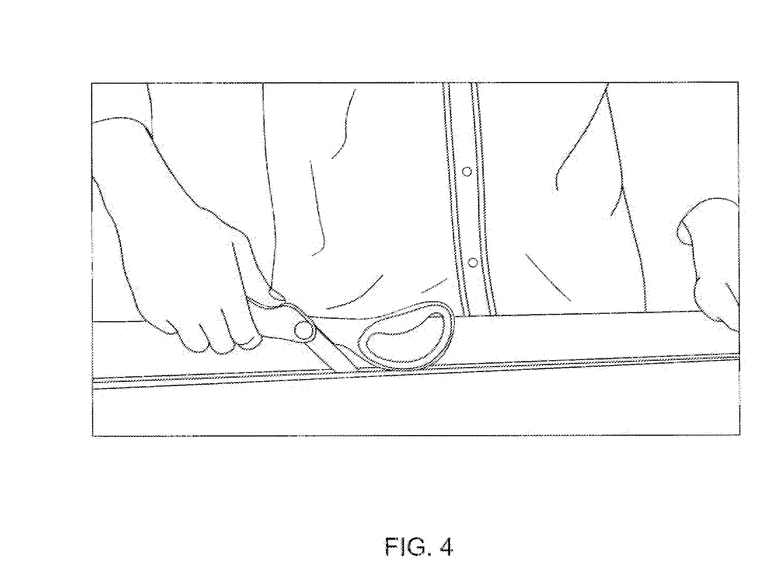

FIG. 4 depicts exemplary usage of an embodiment as “box cutter” to slice tape on a cardboard box.

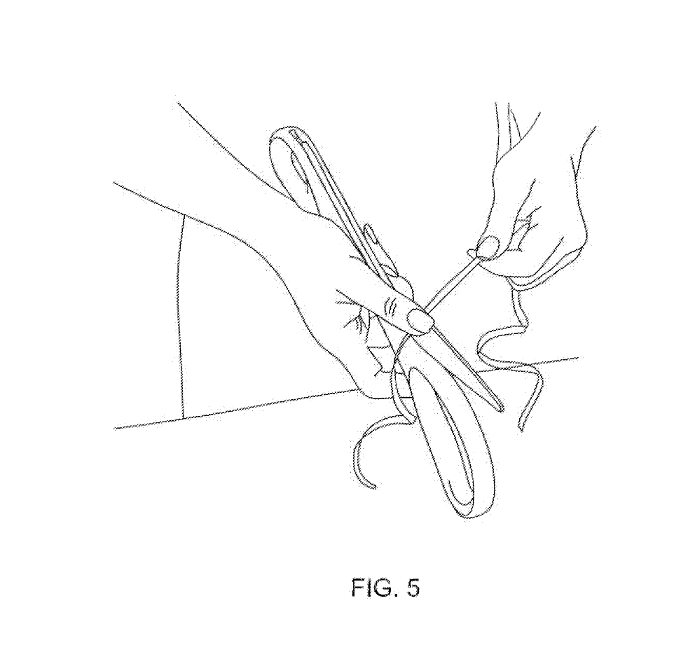

FIG. 5 depicts exemplary usage of an embodiment for curling ribbons.

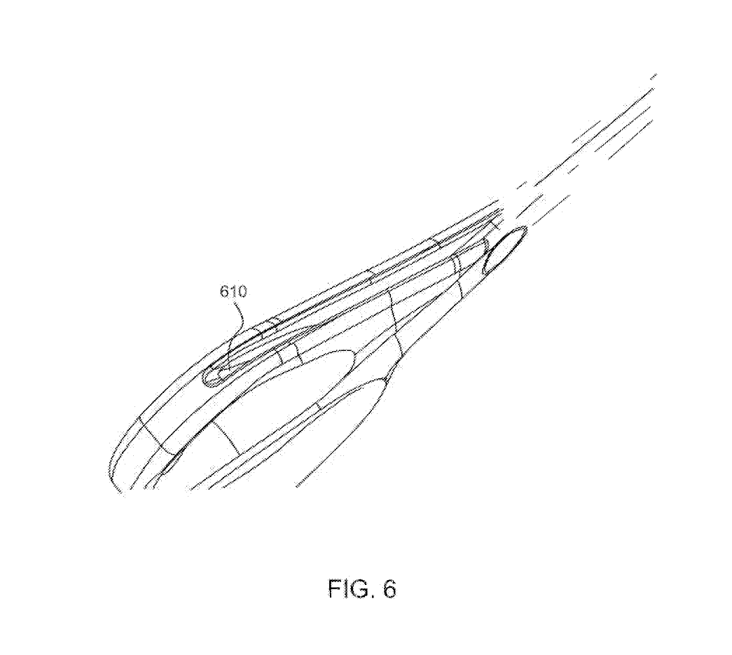

FIG. 6 is a line drawing of an exemplary embodiment, showing a groove 610 in a handle, configured to receive an opposing blade.

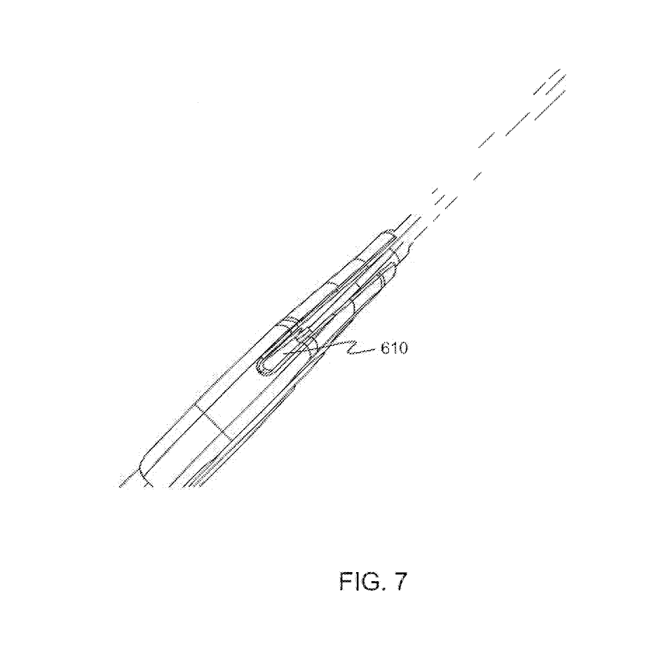

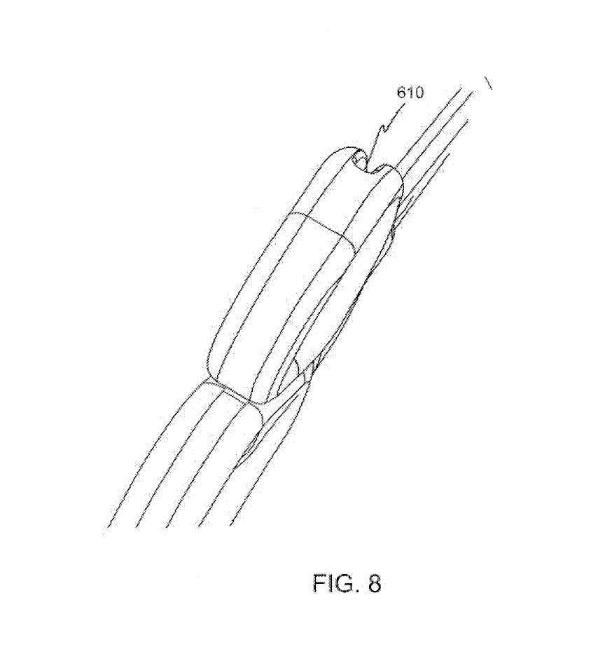

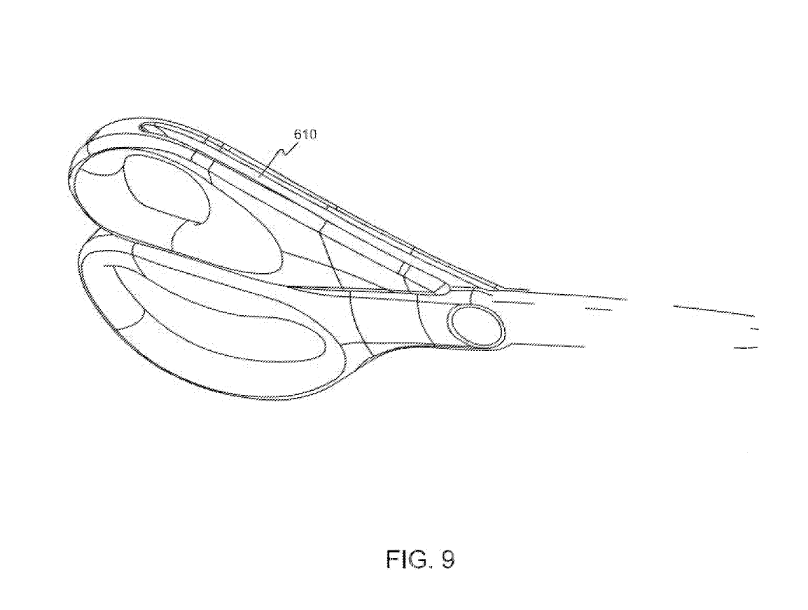

FIGS. 7-9 provide additional views of a handle comprising groove 610.

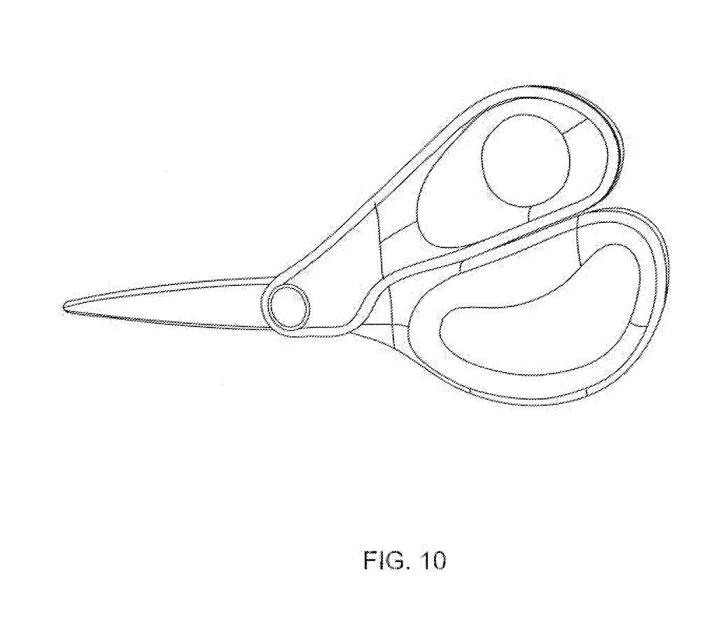

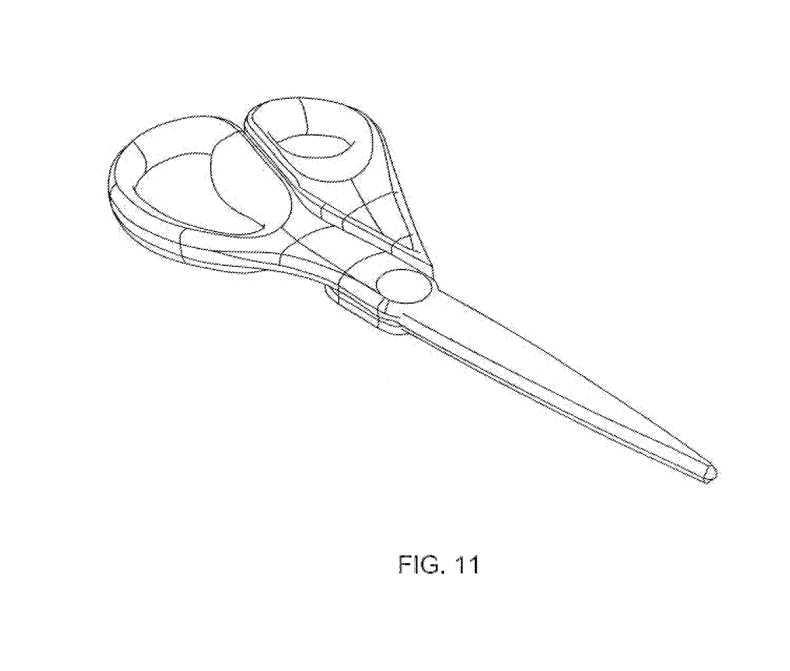

FIGS. 10-11 are line drawings of an exemplary embodiment.

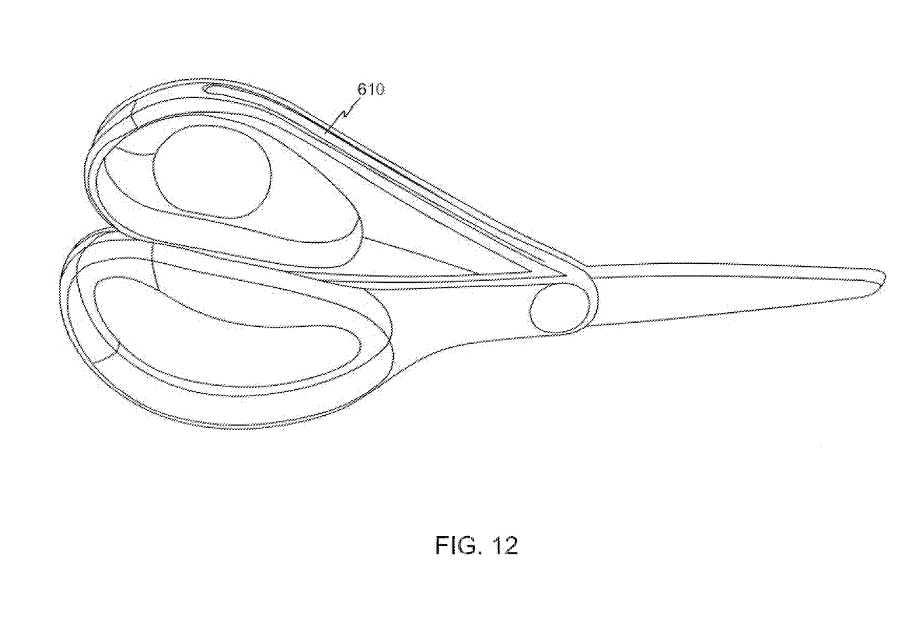

FIG. 12 is a line drawing showing certain internal components of an exemplary embodiment.

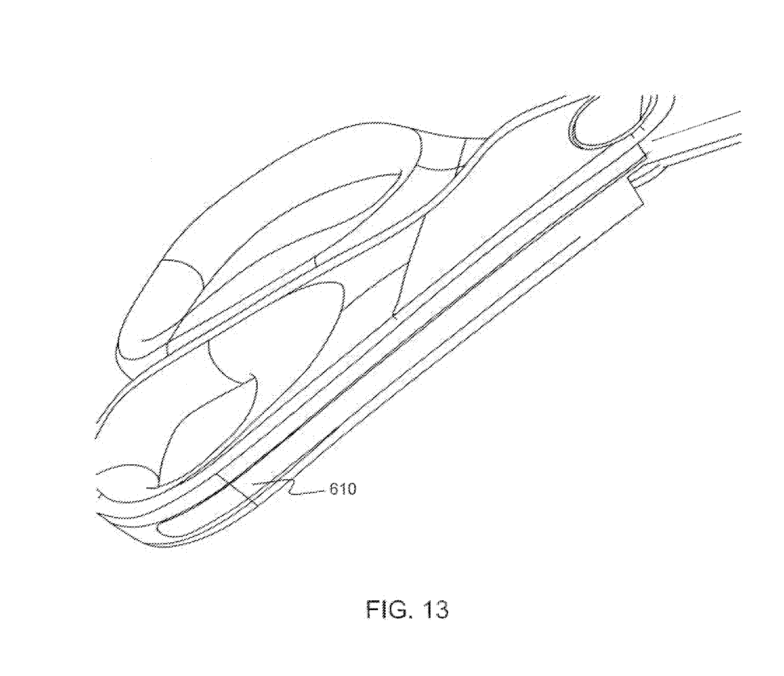

FIG. 13 is another view depicting a groove 610 in a handle of an embodiment.

While certain exemplary aspects and embodiments have been described herein, many alternatives, modifications, and variations will be apparent to those skilled in the art. Accordingly, exemplary aspects and embodiments set forth herein are intended to be illustrative, not limiting. Various modifications may be made without departing from the spirit and scope of the disclosure.

We claim:

1. A scissors apparatus comprising:
a first member comprising a first handle component and a first blade component; and
a second member comprising a second handle component and a second blade component;
said second member connected to said first member and pivotally movable with respect to said first member between a fully closed position and a fully open position, and
said second handle component configured to enclose a sharpened portion of said first blade component when said first and second members are in said fully open position.

2. An apparatus as in claim 1, wherein said second handle component is configured to enclose said sharpened portion of said first blade component via a groove in said second handle component.

3. An apparatus as in claim 1, wherein said second handle component uses a friction component in order to keep said sharpened portion of said first blade component secure within said second handle component when said first and second members are in said fully open position.

4. An apparatus as in claim 3, wherein said friction component uses TPE contact with said first blade component.

5. An apparatus as in claim 1, wherein said second handle component uses a tab in order to keep said sharpened portion of first blade component secure within said second handle component when said first and second members are in said fully open position.

6. A method of operating the apparatus of claim 1, comprising:
operating said apparatus as scissors;
opening said apparatus so that said first and second members are in said fully open position; and
operating said apparatus as a single-blade cutting device.
